(19) United States
(12) Patent Application Publication
(10) Pub. No.: US 2009/0141514 A1
(43) Pub. Date: Jun. 4, 2009

(54) Brake caliper illumination system

(76) Inventor: Andrew L. Palkovic, Grafton, WI (US)

Correspondence Address: RYAN KROMHOLZ & MANION, S.C., POST OFFICE BOX 26618, MILWAUKEE, WI, 53226, US

(21) Appl. No.: 12/284,444

(22) Filed: Sep. 22, 2008

Related U.S. Application Data
(60) Provisional application No. 60/994,563, filed on Sep. 20, 2007.

(51) Int. Cl. F21V 1/00

(52) U.S. Cl. 362/509

(57) ABSTRACT

Illumination of indicia positioned in or on a brake caliper via a removable and interchangeable back plate, face plate, housing, and illumination source mounted to or within or on a pocket in the housing of the caliper face is disclosed.

### RELATED APPLICATIONS

This application claims the benefit of U.S. Provisional Patent Application Ser. No. 60/997,563, filed 20 Sep. 2007, end entitled “Brake Caliper Illumination System,” which is incorporated herein by reference.

### FIELD OF THE INVENTION

The invention relates generally to vehicle enhancements, and more particularly to systems for customization and/or illumination of vehicle brake calipers.

### BACKGROUND OF THE INVENTION

It is quite common to customize a vehicle with various ornamental or esthetic features. Customization can be done both by the original equipment manufacturer (OEM) and/or by the vehicle owner using aftermarket products. The range of customization available is extensive, and can include customization of everything from the headlight(s) to the tailpipe(s) and everything in-between. As an example, aftermarket kits are available to provide a neon-like glow effect that illuminates an automobile's underbody.

Vehicle wheels typically include relatively large openings or areas between the spokes, especially on sportier models. In the automobile for example, the brake caliper is visible through the spokes. It is visible both while the wheel is stationary and in motion. Both OEMs and aftermarket customizers strive to make the caliper stand out. A manufacturer may engrave the logo of the company into the face of the caliper along with offering the consumer color options. As an example, Porsche vehicles typically have the Porsche logo engraved into the face of the caliper, as well as the calipers being painted bright colors such as red and yellow so that the caliper stands out from the rest of the braking system. Along the same lines, aftermarket caliper covers are available that can be attached to the caliper. An example is disclosed in U.S. Design Pat. No. D476,275.

Devices that illuminate portions of automobile wheels and brake calipers are known. For example, U.S. Pat. No. 6,612,726 discloses a device having an array of light-emitting diodes (LEDs) mounted to a bracket that is extended off the side of the brake caliper. The LEDs are connected to a battery power source that can be either part of the vehicle or standalone. The lights are controlled through a microprocessor and are triggered as to provide a strobe effect when the vehicle is moving. As another example, U.S. Pat. No. 7,160,009 discloses a wheel rim illumination system that mounts to the top of the brake caliper for providing backlight for the wheel rim when the vehicle is driven in the dark. As yet another example, U.S. Pat. Pub. No. 2006/0268562 discloses an illumination apparatus that mounts to the outside of a brake caliper. The apparatus includes illumination elements and may be connected to the vehicles power source.

There remains a need for a mechanically and environmentally sound vehicle brake caliper illumination system that is integral with the brake caliper to provide an unlimited range of removable and interchangeable indicia and colors for customization of vehicles. The present invention addresses these needs and solves the mechanical and environmental deficiencies of known illumination systems in the manner described below.

### SUMMARY OF THE INVENTION

The invention comprises illumination means to provide the illumination of indicia (e.g., lettering or logos) on an inside or outside face of a vehicle caliper via a removable and interchangeable back plate and face plate mounted within the housing of the caliper face. The face plate may mount flush with the front of the caliper body within a machined out pocket.

### BRIEF DESCRIPTION OF THE DRAWINGS

FIG. 1 is a side view of a vehicle brake caliper and rotor, showing the brake caliper illumination system of the present invention.

FIG. 2 is a section view of the brake caliper taken generally along line 2-2 in FIG. 1, showing the brake caliper illumination system configured within the side of the brake caliper.

FIG. 3 is an exploded view of the brake caliper illumination system and associated brake caliper.

FIG. 4 is a side view of the brake caliper shown in FIG. 1, showing the brake caliper illumination system configured within the side of the brake caliper, with the back plate and faceplate removed.

FIG. 5 is a perspective view of the brake caliper illumination system connected to an automobile electrical system.

FIG. 6 is a perspective view of a vehicle brake caliper and rotor, showing an alternative embodiment of the brake caliper illumination system of the present invention.

FIG. 7A is a front view of the housing for the brake caliper illumination system shown in FIG. 6.

FIG. 7B is a section view taken along line 7B-7B in FIG. 6, showing mounting apertures for the brake caliper illumination system.

FIG. 7C is a section view taken along line 7C-7C in FIG. 6, showing a cross section of the brake caliper illumination system.

FIG. 7D is a rear view of the housing shown in FIG. 7A

FIG. 8 is a perspective view of the brake caliper illumination system connected to an automobile electrical system, with the illumination system operating with the blinker system of the automobile.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

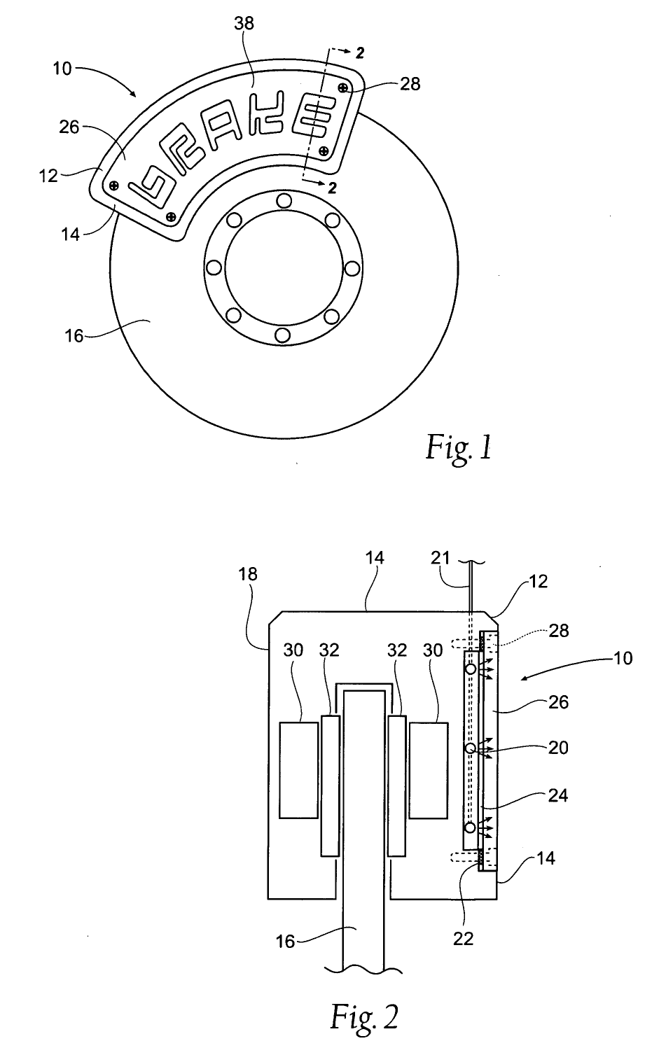

Referring to the drawings in greater detail, FIG. 1 shows a brake caliper illumination system 10 that embodies the features of the present invention. The brake caliper illumination system 10 is shown coupled to or mounted within the outside facing surface 12 of a vehicle brake caliper 14 that is mounted over a moveable rotor 16. The term “vehicle” is intended to have the broadest possible meaning, and can include any type of vehicle having one or more brake calipers, such as but not limited to cars, trucks, motorcycles, airplanes, snowmobiles, and the like. As shown, the system 10 is mounted within the outside facing surface 12 of the caliper 14. The system 10 may also be configured to be mounted within the inside facing surface 18 of the brake caliper 14, or both the outside facing surface 12 and inside facing surface 18, such as may be desired for customization of a motorcycle.

As can be seen in FIGS. 2 through 4, the system 10 may include an illumination source 20 and associated power and control wiring 21, a weather tight gasket 22, a translucent or transparent back plate 24, and a face plate 26. The caliper 14 is shown including brake pistons 30 and brake pads 32.

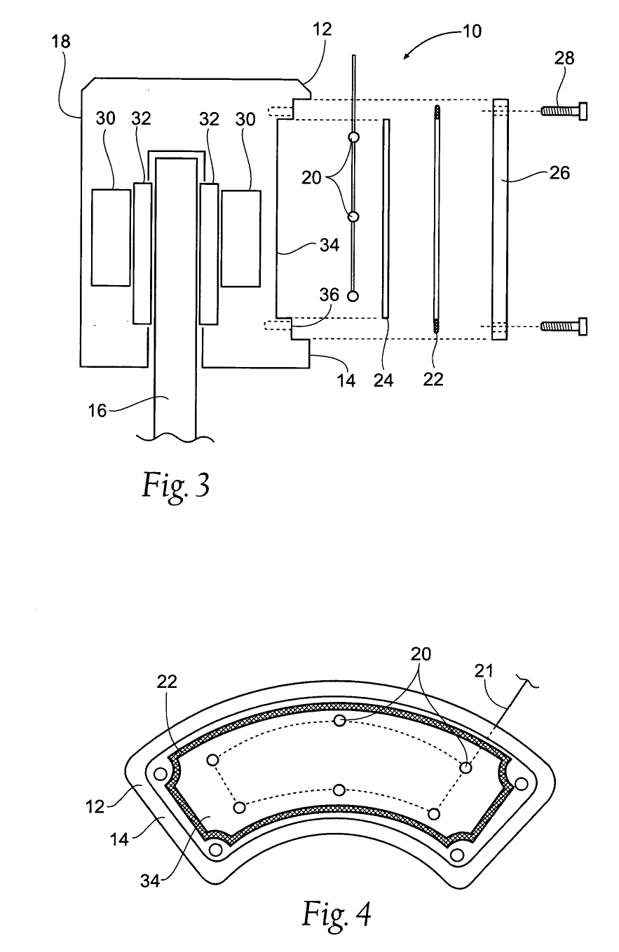

A machined out pocket 34 provides the space and clearance for the system 10 (see FIG. 3). The pocket 34 may be part of the form when the brake caliper is manufactured by the OEM, or the pocket 34 may be machined out during the after-market customization process. It is to be appreciated that the pocket 34 may be formed, i.e., created, at any time by anyone, including for example, by an after-market company that sells brake kits that creates the pocket during their caliper manufacturing process for after-market and/or OEM customers. Other skilled persons may adapt a brake caliper, for example, after the caliper(s) are purchased from an after-market or OEM company, including calipers on a high end car that has calipers and the car owner would like the brake calipers modified without replacing the brake calipers.

The illumination source 20 and back plate 24 may be mounted in the pocket 34. The face plate 26 may then be secured to the caliper 14 using securing means 28 such as bolts, screws, nails, rivets, glue, or the like. The face plate 26 may be positioned in front of the illumination source 20 and the back plate 24 within the pocket 34. The gasket 22 may be mounted in a machined out groove 36 to provide a weather tight seal to keep out water and other debris. The gasket 22 may be positioned between the caliper 14 and the back plate 24, or between the back plate 24 and face plate 26, as shown, or more than one gasket 22 may be used.

The source of illumination 20 may come from a variety of light generating means such as, but not limited to light emitting diodes (LED), neon, or any other known light generating sources. Vibration resistant light generating means are desirable.

The translucent or transparent back plate 24 may comprise a plastic or other similar material that would allow light to pass through, and would be available in any desired color or combinations of colors, including clear. The back plate 24 will mount behind the face plate 26 and over the illumination source 20. The translucent back plate 24 may be removable and interchangeable.

The face plate 26 may comprise a plastic or metal, and may be molded or machined or pressed or otherwise formed to display any indicia 38, such as text, a logo, design, or even a car club an individual belongs to. FIG. 1 shows the letters “BRAKE” as an example. Behind the face plate 26 would be the back plate 24. The face plate 26 may also be removable and interchangeable.

The combination of a translucent back plate 24 and a custom face plate 26 provides an unlimited combination of color and engraving choices for the consumer. This will allow for the ultimate customization and personalization of a vehicle's calipers.

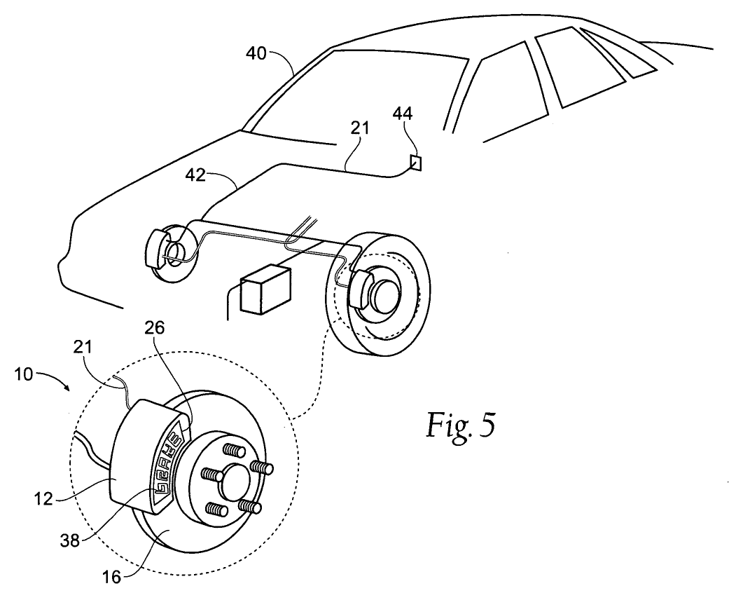

In an exemplary embodiment, the system 10 is shown in use with an automobile 40. As can be seen in FIG. 5, the illumination source 20 may be electrically coupled to the power and/or control circuit 42 with the power and control wiring 21. The power and/or control circuit 42 operates the brake and tail lights (not shown). A portable power source (not shown) may be used to power the system 10, or the system 10 may use the vehicles battery to provide power to the illumination source 20.

In one embodiment, when the brake lights come on, the brake caliper illumination system 10 would also illuminate. In a night driving example, the system 10 would illuminate when the headlights and/or fog lights are turned on, and become brighter with the application of the brakes.

The system 10 may also include a control switch 44 mounted on the vehicle dash or center console of a vehicle (i.e., within the control of the driver). This would allow the vehicle driver to control the system 10, such as turn the system on or off, and/or to brighten or dim the illumination source 20, as desired. The system 10 may be usable and controllable when the automobile 40, or any other vehicle using the system), when the automobile is not moving and turned off, i.e., when the vehicle is parked at a vehicle show. A remote control device may also be used to control the operation of the system 10.

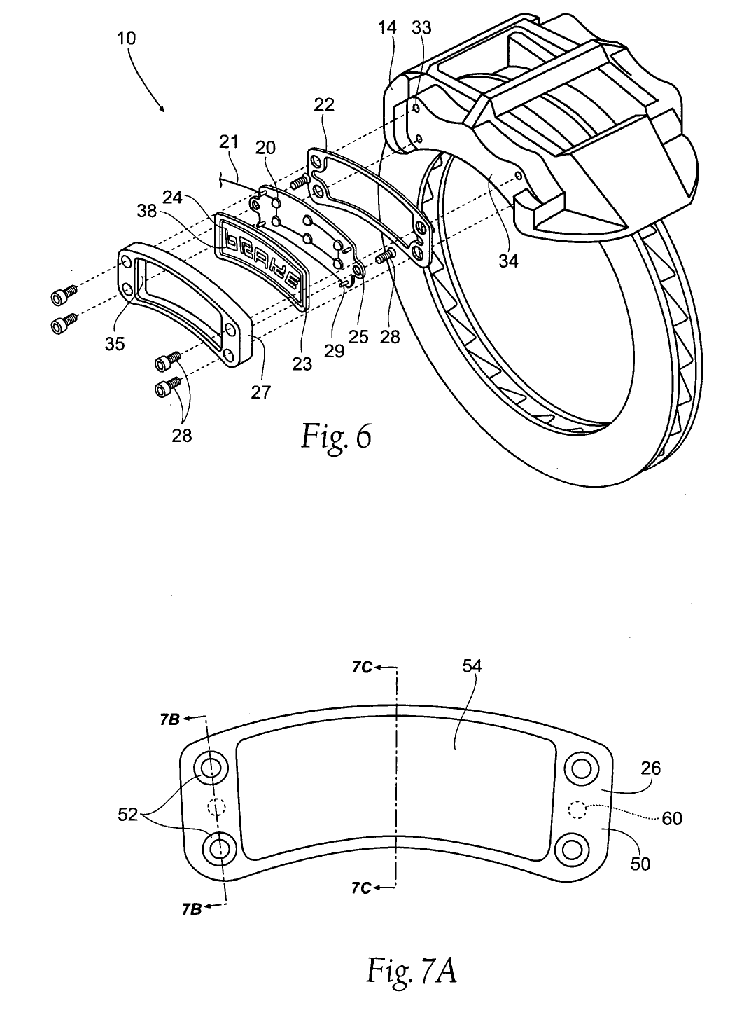

An alternative embodiment of the system 10 is shown in FIG. 6. As can be seen, the system 10 may include the illumination source 20 and associated power and control wiring 21, the weather tight gasket 22, the translucent or transparent back plate 24, a back cover 25, and a housing 27. The caliper 14 is shown including a machined out pocket 34 that provides the space and clearance for the system 10, and mounting apertures 33 to mount the system 10 to the brake caliper. As previously described, the pocket 34 may be part of the form when the brake caliper 14 is manufactured by the OEM, or the pocket 34 may be machined out during the after-market customization process. As previously described, the pocket 34 may be created at any time by anyone.

The housing 27 is shown including a space or pocket 35. The pocket 35 is sized and configured to provide space for the translucent back plate 24, the illumination source 20, and the back cover 25. The housing 27 may comprise a plastic or metal, and may be molded or machined or pressed or otherwise formed to house the translucent back plate 24, the illumination source 20, and the back cover 25. The gasket 22 may also be partially held in the pocket 35.

A gasket 23 may also be included within the pocket 35 or on or part of the translucent back plate 24 to proved a seal on the front side of the system 10. The back plate 24 may then be secured to the housing 27 using securing means 28. In this configuration, the system 10 can be assembled into a complete device or system that is then secured to the caliper 14, again using securing means 28. This allows the system 10 to be installed and removed as a single unit, as compared to multiple components, which allows for simpler and faster installation.

The translucent back plate 24 is positioned within the pocket 35 and in front of the illumination source 20, with the illumination source 20 adapted to be mounted to the back cover 25, although the illumination source 20 may also be mounted to the back plate 24, or the illumination source may not be mounted to either of the back plate 24 or back cover 25. As seen in FIG. 6, one or more spacers 29 may be coupled to the back cover 25 (or optionally to the translucent back plate 24, to provide a space for the illumination source 20.

The gaskets 22 and/or 23 may be mounted in a machined out groove to provide a weather tight seal to keep out water and other debris. The gaskets 22 and/or 23 may be positioned between components, such as the caliper 14 and the back cover 25, as shown, or between the housing 27 and translucent back plate 24, for example. It is to be appreciated that a variety of gasketing configurations may be used, as would be understood by one skilled in the art.

The translucent back plate 24 may comprise a plastic or other similar material and would be available in any desired color or combinations of colors, including clear. The translucent back plate 24 may be removable and interchangeable. As previously described with the face plate 26, the translucent back plate 24 may comprise a plastic or metal, and may be molded or machined or pressed or screened or otherwise formed or modified to display any indicia 38, such as text, a logo, design, or even a car club an individual belongs to. FIG. 6 shows the letters “BRAKE” as an example. Use of the translucent back plate 24 within the housing 27 provides an unlimited number of options of color and engraving choices for the consumer. This will allow for the ultimate customization and personalization of a vehicle's calipers.

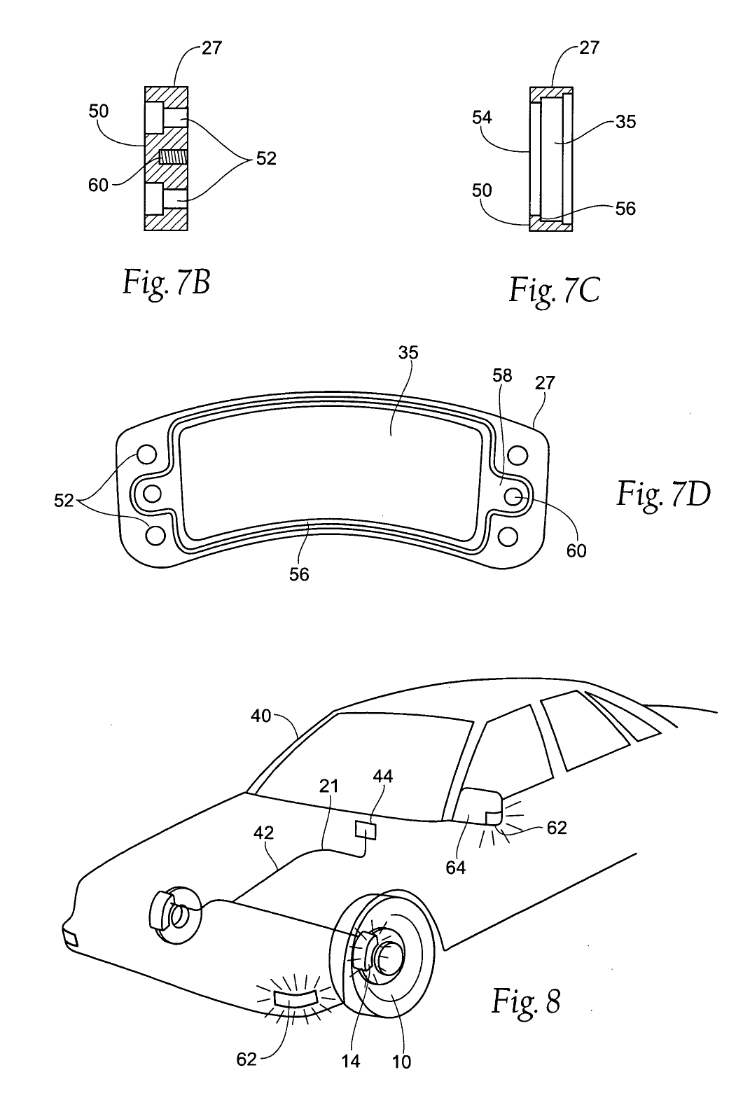

FIGS. 7A through 7D show details of the housing 27. As can be seen, the front 50 of the housing 27 includes mounting apertures 52 for mounting the system 10 to the brake caliper 14, and a viewing aperture 54 for viewing the logo on the translucent back plate 24. FIG. 7D shows a rear view of the housing 27, showing a first recess 56 adapted for positioning of the translucent back plate 24, and a second recess 58 adapted for positioning of the back cover 25. In addition, mounting apertures 60 are shown, the mounting apertures 60 extending only partially into the housing 27. The mounting apertures allow the back cover 25 to be mounted to the housing 27.

FIG. 8 shows an additional use of the system 10. In this configuration, the system 10 may be coupled to the turn signal 62 (i.e., blinker) system. When the driver turns on a blinker, a left blinker for example, the left front and/or left rear brake caliper illumination systems may also illuminate and/or flash, or their intensity (if already illuminated) may increase, so as to provide an additional indication that the left blinker is on, similar in concept to the use of blinkers 62 on side view mirrors 64.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An illumination system comprising:
a faceplate adapted to be secured to a pocket within a brake caliper,
a translucent back plate adapted to be mounted between the faceplate and the pocket within the brake caliper,
an illumination source, the illumination source including power and control wiring for coupling to a power supply and a controller, the illumination source adapted to be mounted between the translucent back plate and the pocket within the brake caliper, so as to allow the illumination source to illuminate the translucent back plate, and the illuminated translucent back plate to illuminate through the faceplate, and
a weather tight gasket adapted to be mounted between the faceplate and the pocket within the brake caliper.

2. A system according to claim 1:
further including a brake caliper having a pocket adapted for mounting the illumination system.

3. A system according to claim 1:
wherein the face plate is formed to display an indicia.

4. A system according to claim 1:
wherein the translucent back plate is formed to display an indicia.

5. A system according to claim 1:
wherein the face plate is removable and replaceable.

6. A system according to claim 1:
wherein the translucent back plate is removable and replaceable.

7. A system according to claim 1:
wherein the power wiring is coupled to a vehicle's power wiring to provide power to the illumination source.

8. A system according to claim 1:
wherein the control wiring is coupled to a vehicle's control wiring to control the operation of the illumination source.

9. A system according to claim 1:
wherein the power and control wiring is coupled to a vehicle's power and control wiring to provide power to the illumination source and to control the operation of the illumination source using the vehicle's blinker system.

10. A system according to claim 1:
wherein the control wiring is coupled to a remote control device to allow remote control of the illumination source.

11. An illumination system comprising:
a housing adapted to be secured to a pocket in a brake caliper,
a translucent back plate adapted to be mounted between the housing and the pocket within the brake caliper,
a back cover, the back cover adapted to be mounted to the housing and positioned between the housing and the brake caliper,
an illumination source, the illumination source including power and control wiring for coupling to a power supply and a controller, the illumination source adapted to be mounted between the translucent back plate and the back cover, so as to allow the illumination source to illuminate the translucent back plate, and the illuminated translucent back plate to illuminate through the housing, and
a weather tight gasket adapted to be mounted between the housing and the pocket within the brake caliper.

12. A system according to claim 11:
further including a brake caliper having a pocket adapted for mounting the illumination system.

13. A system according to claim 11:
wherein the translucent back plate is formed to display an indicia.

14. A system according to claim 11:
wherein the translucent back plate is removable and replaceable.

15. A system according to claim 11:
wherein the power wiring is coupled to a vehicle's power wiring to provide power to the illumination source.

16. A system according to claim 11:
wherein the control wiring is coupled to a vehicle's control wiring to control the operation of the illumination source.

17. A system according to claim 11:
wherein the power and control wiring is coupled to a vehicle's power and control wiring to provide power to the illumination source and to control the operation of the illumination source using the vehicle's blinker system.

18. A system according to claim 11:
wherein the translucent back plate is mounted within the housing and between the housing and the brake caliper.

19. An illumination system comprising:
a housing adapted to be secured to a pocket in a brake caliper,
a translucent back plate adapted to be mounted between the housing and the pocket within the brake caliper,
an illumination source, the illumination source including power and control wiring for coupling to a power supply and a controller, the illumination source adapted to be mounted between the housing and the pocket within the brake caliper, so as to allow the illumination source to illuminate at least one of the translucent back plate and the housing, and
a weather tight gasket adapted to be mounted between the housing and the pocket within the brake caliper.

20. A system according to claim 19:
further including a brake caliper having a pocket adapted for mounting the illumination system.
